(19) United States
(12) Patent Application Publication
(10) Pub. No.: US 2025/0353709 A1
(43) Pub. Date: Nov. 20, 2025

(54) Compact Winch System

(71) Applicant: Westin Automotive Products, Inc., San Dimas, CA (US)

(72) Inventors: Jeremy Lanini, Minden, NV (US); Jake Eggan, Los Angeles, CA (US); Jose Eduardo Lopez Moctezuma, La Mirada, CA (US)

(21) Appl. No.: 18/936,940

(22) Filed: Nov. 4, 2024

Related U.S. Application Data
(60) Provisional application No. 63/647,784, filed on May 15, 2024.

(51) Int. Cl. B66D 1/22; B66D 1/12

(52) U.S. Cl. CPC B66D 1/225; B66D 1/12

(57) ABSTRACT

The present invention provides a compact winch system that reduces the required space for a winch after-market accessory for a vehicle by using a small DC motor with a planetary gearbox assembly having at least four planetary stages and a gear control assembly that together provide a choice of a low range gear reduction and a high range gear reduction that allows the motor to retain the pulling power of a conventional winch system. Alternatively, the compact winch system creates its compactness through the use of a set of spur gears that multiply the torque of the motor while simultaneously offsetting the motor in order to create space for its motor controller.

### FIELD OF INVENTION

The present invention relates to the vehicle accessory field. More specifically, it relates to a winch system for use in vehicles, especially for four-wheel drive and/or off-road vehicles.

### BACKGROUND OF INVENTION

As modern four-wheel drive vehicles become optioned with more and more features, they are in turn becoming heavier with limited space to mount aftermarket accessories. This creates the need for a more compact winch designed to fit into tight spaces yet still retaining the pulling power of conventional winching systems. Most modern vehicle mounted electric recovery winches utilize a relatively large direct current (“DC”) motor (e.g., 5 horsepower or greater and hereinafter referred to as “Conventional Winch Motor”). The Conventional Winch Motor requires a motor controller that can handle larger amperage (e.g., 400 amps to 600 amps @ 12 volts). The greater horsepower required for the Conventional Winch Motor and larger amperage required for its motor controller increase their respective physical sizes. The Conventional Winch Motor sends power through a driveshaft and into two or three stages of planetary gears that develop the torque necessary to drive the winch drum. The large physical sizes of the Conventional Winch Motor and its corresponding motor controller create a winch system that is large, generally misshapen, and often difficult to find a practical place to mount on a modern vehicle.

The present invention presents a compact winch system 100 described below that overcomes this problem and reduces the required space or footprint for a winch after-market accessory for a vehicle.

### BRIEF DESCRIPTION OF THE DRAWING

The present invention will be more clearly understood when considering the accompanying drawing of which:

FIG. 1 shows a perspective view of a compact winch system in accordance with the principals of the present invention;

FIG. 2 shows a front view of the compact winch system of FIG. 1;

FIG. 3 shows a rear view of the compact winch system of FIG. 1;

FIG. 4 shows a top view of the compact winch system of FIG. 1;

FIG. 5 shows a bottom view of the compact winch system of FIG. 1;

FIG. 6 shows a side view of the compact winch system of FIG. 1;

FIG. 7 shows a side view of the compact winch system of FIG. 1 that is opposite of the side view shown in FIG. 6;

FIG. 8 shows a front view of the winch assembly of the compact winch system of FIG. 1;

FIG. 9 shows an exploded front perspective view of the winch assembly shown in FIG. 8;

FIG. 10 shows a side view of the winch assembly shown in FIG. 8;

FIG. 10A shows a side view of another embodiment of the winch assembly shown in FIG. 8 wherein the gear offset allows the motor controller to be placed in a different location compared to its location shown in FIG. 10;

FIG. 10B shows a side view of another embodiment of the winch assembly shown in FIG. 10 wherein the gear offset allows the motor controller to be placed in a different location compared to its location shown in FIG. 10 or FIG. 10A;

FIG. 10C shows a side view of yet another embodiment of the winch assembly shown in FIG. 10 wherein the gear offset allows the motor controller to be placed in a different location compared to its location shown in FIG. 10, 10A, or FIG. 10B;

FIG. 11 shows a perspective view of another exemplary embodiment of a compact winch system in accordance with the principals of the present invention;

FIG. 12 shows a front view of the compact winch system of FIG. 11;

FIG. 13 shows a rear view of the compact winch system of FIG. 11;

FIG. 14 shows a top view of the compact winch system of FIG. 11;

FIG. 15 shows a bottom view of the compact winch system of FIG. 11;

FIG. 16 shows a side view of the compact winch system of FIG. 11;

FIG. 17 shows a side view of the compact winch system of FIG. 11 that is opposite of the side view shown in FIG. 16;

FIG. 18 shows a front view of certain components of the first winch assembly of the compact winch system of FIG. 11;

FIG. 19 shows an exploded front perspective view of the first winch assembly of the compact winch system of FIG. 11;

FIG. 20 shows a side view of the third planetary stage assembly of the winch assembly shown in FIG. 19; and

FIG. 21 shows a cross-section view of the first planetary gearbox assembly of the winch assembly shown in FIG. 19.

### DESCRIPTION OF THE PREFERRED EMBODIMENT

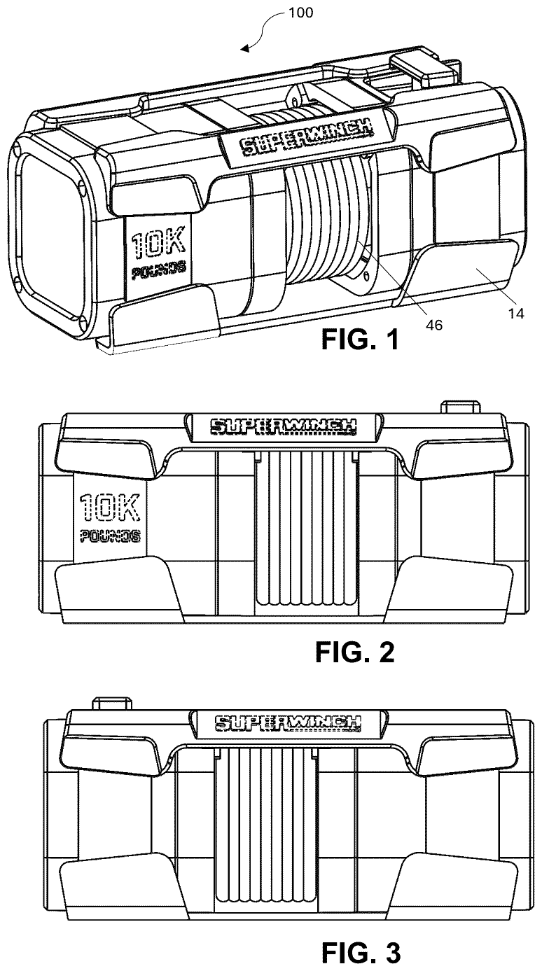

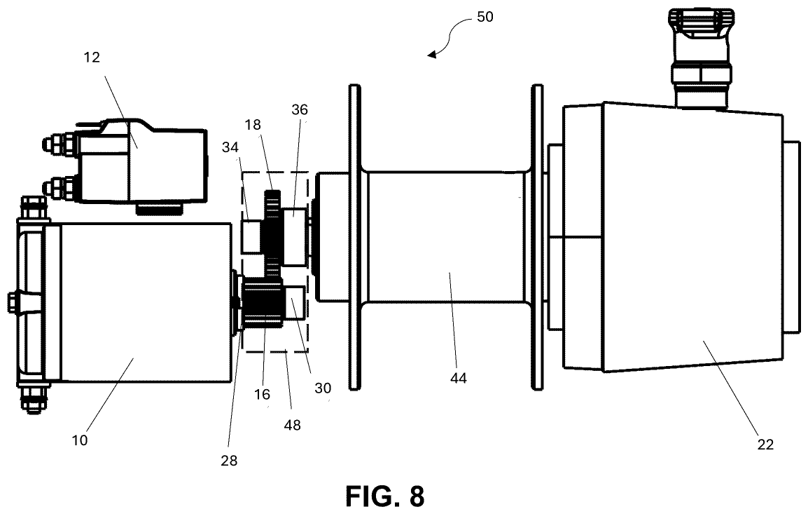

Referring to FIGS. 1-9, the present invention presents a compact winch system 100 that reduces the required space or footprint for a winch after-market accessory for a vehicle. The system 100 includes a winch assembly 50, a housing 14 for the first winch assembly 50 and a winch rope or cable 46 (hereinafter collectively referred to as “winch cable”). The winch assembly 50 includes a DC motor 10 having an output shaft 24, a motor controller 12, a motor spur gear 16 having a first diameter and a first tooth count, a drum spur gear 18 having a second diameter and a second tooth count, a first motor bearing 26, a second motor bearing 30, a first motor spacer 28, a second motor spacer 32, a first drum bearing 34, a second drum bearing 36, a first drum spacer 38, a second drum spacer 40, a brake assembly 42, a drive shaft 20, and a planetary gearbox assembly 22. The motor controller 12 further includes an electrical control device that directs electricity from an electrical source to the motor controller 12 and the motor 10. The electrical control device is capable of reversing polarity of the DC current in order to cause the motor 10 to run forward, reverse, or full stop.

The system 100 reduces its required space and creates its compactness through the use of a set of spur gears (16, 18) that multiply the torque of the motor 10 while simultaneously offsetting the motor 10 in order to create space for the motor controller 12. Once the torque has been multiplied power transfers through a driveshaft 20 and into the planetary gearbox assembly 22 containing planetary gear stages in the same fashion as a traditional modern winch.

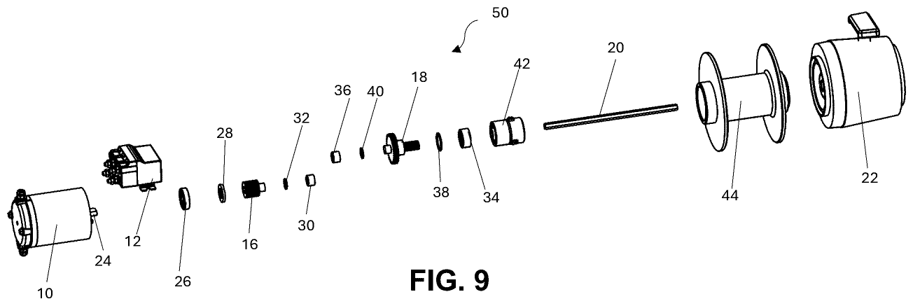

Referring to FIG. 9, power in the form of horsepower and torque is generated by the motor 10 and output to the output shaft 24 of the motor 10. The output shaft 24 is coupled and supported by the first motor bearing 26. The motor side spur gear 16 is also coupled to the output shaft 24 with the first motor spacer 28 between the motor side spur gear 16 and the first motor bearing 26. The second motor bearing 30 is coupled to the motor side spur gear 16 with the second motor spacer 32 between the motor side spur gear 16 and the second motor bearing 30. The on/off, forward and reverse function of the motor 10 is controlled by the art-disclosed motor controller 12 (e.g., an electrical control unit or the like). Power generated by the motor 10 is transferred into the motor side spur gear 16 which is coupled to the output shaft 24, spaced by the first motor spacer 28. The motor side spur gear 16 is supported by the output shaft 24 along with the second motor bearing 30. The second motor spacer 32 spaces the second motor bearing 30, while providing a thrust surface.

Power is then transferred from the motor side spur gear 16 to the drum side spur gear 18. The drum side spur gear 18 is of a larger diameter and has a higher tooth count than the motor side spur gear 16. This results in a torque increase and speed decrease. In addition, the offset 48 created by this transition/engagement between the motor side spur gear 16 and the drum side spur gear 18 results in moving the axis of power flow.

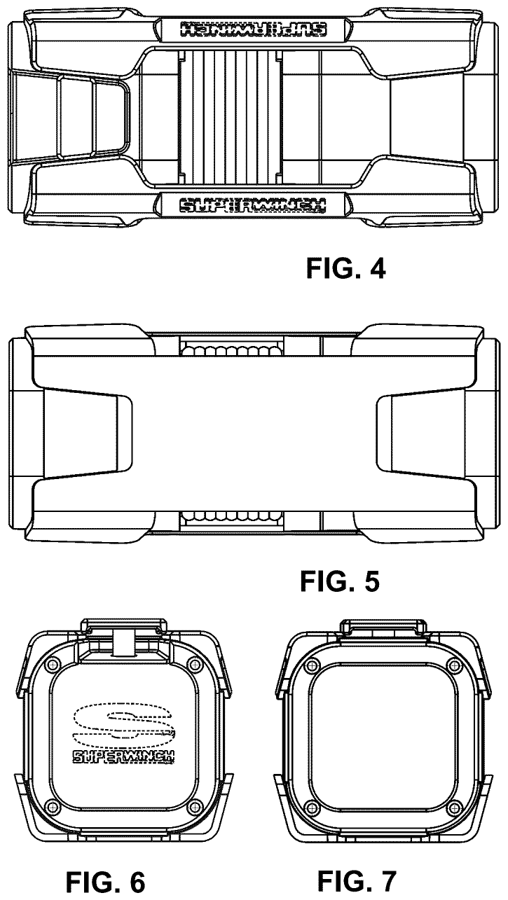

Referring to FIG. 9, the drum side spur gear 18 is supported by the first drum bearing 34 and the second drum bearing 36. The first drum spacer 38 is placed between the first drum bearing 34 and the drum side spur gear 18. The second drum spacer 40 is placed between the drum side spur gear 18 and the second drum bearing 36. Power then flows from the drum side spur gear 18 into the system's brake assembly 42, then into the driveshaft 20, then from the driveshaft 20 into the planetary gearbox assembly 22 containing a series of planetary gear stages. The planetary gearbox assembly 22 further increases torque while reducing speed through the series of art-disclosed planetary gear stages. Power then travels out of the planetary gearbox assembly 22 and into the winch drum 44. The winch rope/cable (hereinafter referred to as “winch cable” 46 and as shown in FIG. 4) is attached to the winch drum 44. The power ultimately transferred into the winch drum 44 is transferred to the winch cable 46 for use in winching operations.

The bearings (26, 30, 34, 36) can be any suitable art-disclosed bearings (e.g., ball bearings, needle bearings, or the like). The spacers (28, 32, 38, 40) can be any suitable art-disclosed spacers including washers.

For operation of the compact winch system 100, the motor 10 outputs power in the form of speed and torque to the motor spur gear 16 via the output shaft 24. The motor spur gear 16 engages with the drum spur gear 18 to transfer the power to the drum side spur 18, then into the brake assembly 42, the drive shaft 20, and the planetary gearbox assembly 22. The engagement of the motor spur gear 16 with the drum spur gear 18 multiplies the torque generated by the motor 10, moves axis of the power flow from the motor 10 to the planetary gearbox assembly 22 with the offset 48 of the motor's (10) location to create a desired physical location for the motor controller 12. The planetary gearbox assembly 22 transfers the power created by the motor 10 into the winch drum 44 which is then transferred to the winch cable 46 for use in winching operations.

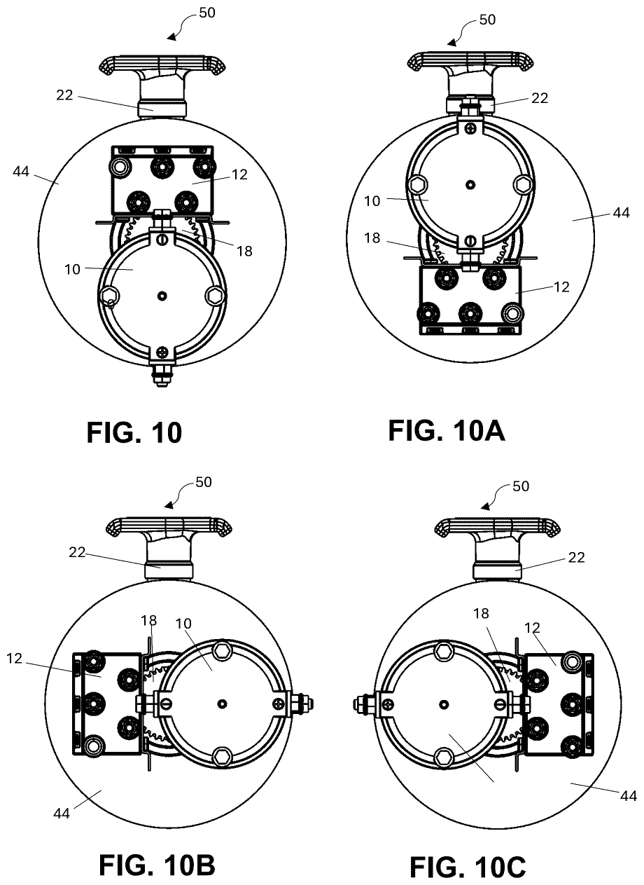

The offset 48 created by the engagement of the motor spur gear 16 and the drum spur gear 18 provides the desired room or space for the motor controller 12. Referring to FIGS. 10 and 10A-C showing exemplary embodiments of the winch system 100 without the housing 14 and the winch cable 46, the offset 48 can be in any suitable desired angle to achieve the purpose of allowing the motor controller 12 to be located in any desired location around the motor 10.

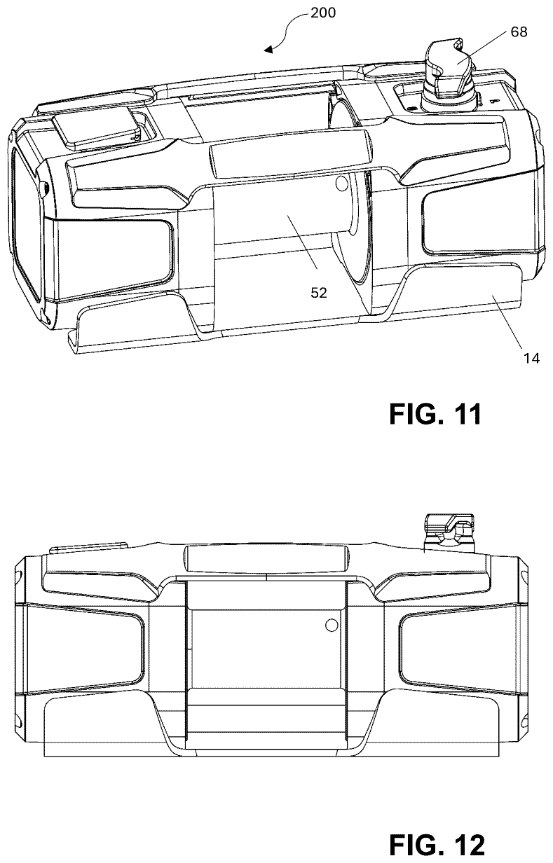

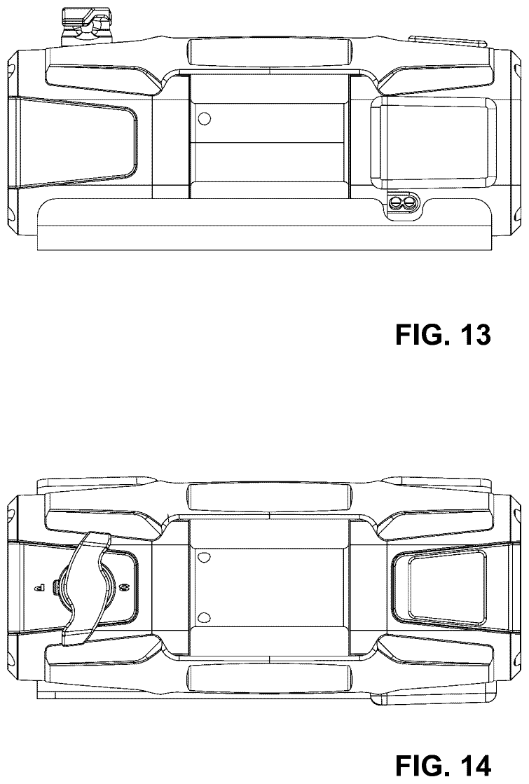

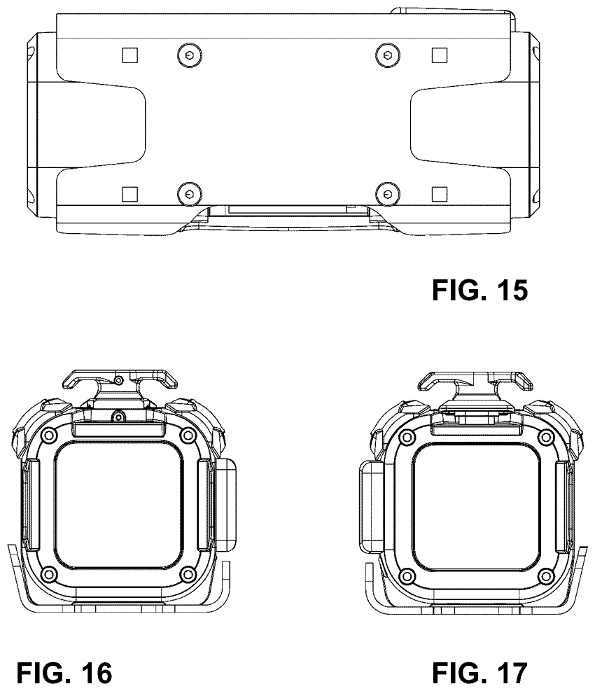

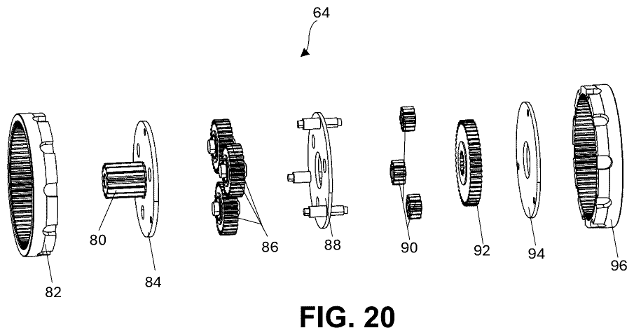

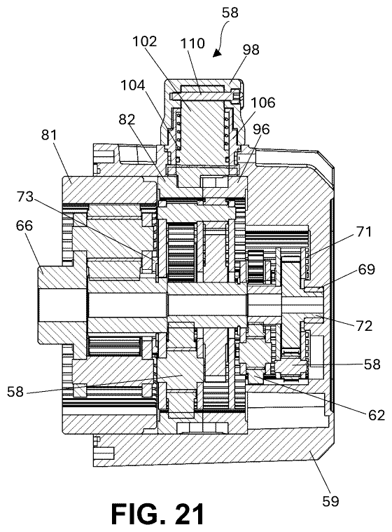

Referring to FIGS. 11 to 21, the present invention provides another compact winch system 200 that does not have the offset 48. Instead, the system 200 creates its compactness by replacing the motor 10 and the motor controller 12 with a first motor 54 and a first motor controller 56 that are smaller in size compared to a Conventional Winch Motor and its corresponding motor controller. The first motor controller 56 includes an art-disclosed electrical control unit 55 that directs electricity from an electrical source to the first motor controller 56 and the first motor 54. The electrical control unit 55 is capable of reversing the polarity of the DC electrical current in order to cause the first motor 54 to run forward, reverse, or full stop. The system 200 optionally includes a motor cover that encapsulates both the first motor 54 and the motor controller 56 including the electrical control unit 55. The first motor controller 56 can be positioned to the immediate side, top, or bottom of the first motor 54.

Being smaller in size, the first motor 54 is likely to have less horsepower than the Conventional Winch Motor. For example, suitable horsepower ranges for the first motor 54 are from 1.5 to 4.5, 1.5 to 4, 1.5 to 3, and 1.5 to 2.5, and 1.5 to 2.2. Correspondingly, the first motor controller 56 is likely to require less amperage and smaller in physical size than the motor controller required for the Conventional Winch Motor. For example, suitable amperage for the first motor controller 56 are from 120 amps to 200 amps at 12 volts, from 180 amps to 250 amps at 12 volts, from 200 amps to 300 amps at 12 volts, from 60 amps to 100 amps at 24 volts, from 90 amps to 125 amps at 24 volts, and from 110 amps to 160 amps at 24 volts.

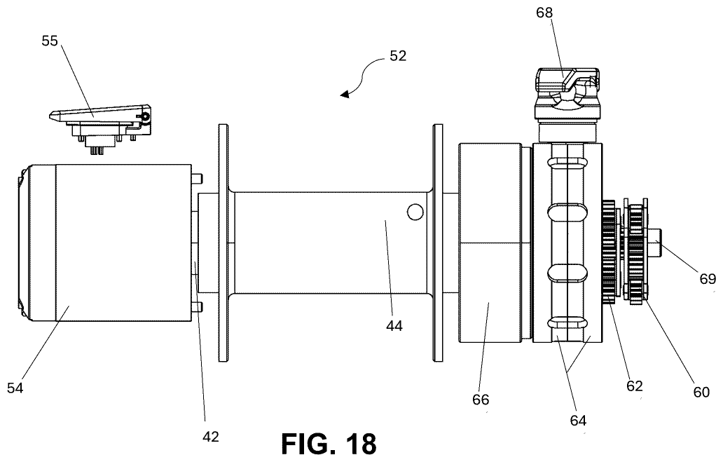

Unlike the winch assembly 50 of the system 100 and referring to FIGS. 18-21, the system 200 includes a first winch assembly 52 that does not include the set of spur gears (16, 18), their associated bearings (30, 34, 36) and spacers (28, 32, 38, 40) thus the offset 48 does not exist. However, the system 200 does include the housing 14 and the winch cable 46 described above for the system 100. Moreover, the first winch assembly 52 also includes the drive shaft 24, the output shaft 24, the first motor bearing 26, the brake assembly 42, and the winch drum 44 described above for the system 100. Finally, the first winch assembly 52 further includes a driveshaft support bearing 69 as shown in FIGS. 18, 19 and 21.

In order for the smaller first motor 54 to retain the pulling power of a conventional winch system, the system 200 uses a first planetary gearbox assembly 58 having at least four planetary stages (60, 62, 64, 66) and a gear control assembly 68 that together provide the system 200 with a choice of a low range gear reduction (e.g., gear ratio between 400:1 to 600:1) and a high range gear reduction (e.g., gear ratio between 120:1 to 190:1) of the first motor 54. The first planetary gearbox assembly 58 further includes a planetary gearbox housing 59.

The low range gear reduction multiplies the torque of the first motor 54 in order to provide necessary pulling power to recover a full-size off-road vehicle. Examples of suitable gear ratios for the low range gear reduction by the first planetary gearbox assembly 58 and the first motor 54 are in the ranges between 300:1 to 700:1, between 350:1 to 650:1, between 400:1 to 600:1, and between 400:1 to 500:1. Using the low range gear reduction of the system 200 will likely result in a slower speed when recovering the winch cable 46. Accordingly, one can use the high range gear reduction of the system 200 when a faster speed is desired when recovering the winch cable 46. Examples of suitable gear ratios for the high range gear reduction by the first planetary gearbox assembly 58 and the first motor 54 are in the ranges between 60:1 to 190:1, between 60:1 to 150:1, and between 120:1 to 190:1.

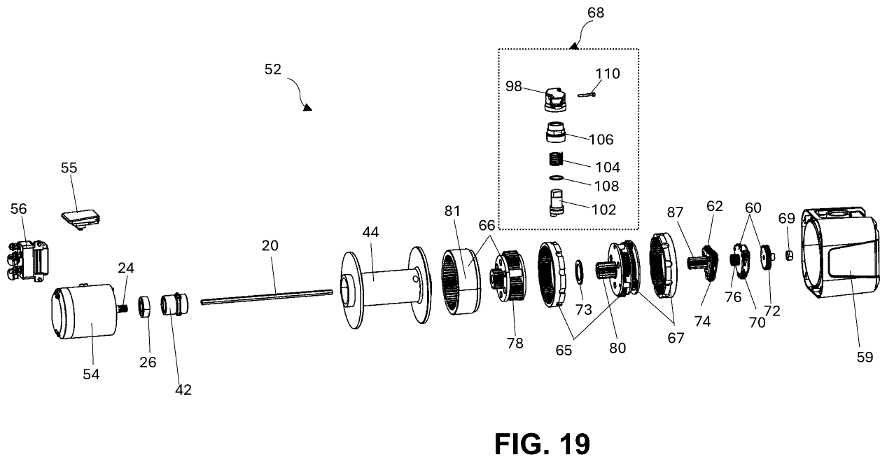

In one exemplary embodiment of the system 200 and referring to FIGS. 19-21, the first planetary gearbox assembly 58 includes a first stage planetary gear assembly 60 having first stage planet gears 70, a first stage annular gear 71, and a first stage sun gear 72; a second stage planetary gear assembly 62 having second stage planet gears 74 and a second stage sun gear 76; a fourth stage planetary gear assembly 66 having a fourth stage planet gears 78, a fourth stage sun gear 80, and a fourth stage annular gear 81.

The first planetary gearbox assembly 56 further includes a third stage planetary gear assembly 64 having a low range planetary gear stage 65 and a high range planetary gear stage 67. The low range planetary gear stage 65 includes a low range annular gear 82 low range planet gears 86, and a low range sun gear 87. The high range planetary gear stage 67 includes high range planet gears 90, a high range sun gear 92, and a high range annular gear 96. The third stage planetary gear assembly 64 further includes a first outer carrier plate assembly 84, a second carrier plate assembly 88, and an outer carrier plate 94. The low range planet gears 86 are (I) retained between the first outer carrier plate assembly 84 and the second carrier plate assembly 88; (ii) located inside and in communication with the low range annular gear 82; and (iii) revolve around the fourth stage sun gear 80.

Referring to FIG. 19, the first planetary gearbox assembly 56 further includes a washer (e.g., a thrust washer) separating the third stage planetary assembly 64 and the fourth stage planetary assembly 66. The high range planet gears 90 are (i) retained between the second carrier plate assembly 88 and the outer carrier plate 94; (ii) located inside and in communication with the high range annular gear 96; and (iii) revolve around the high range sun gear 92. The low range planet gears 86 and the low range sun gear 87 of the planetary gear stage 65 are different in size compared to the high range planet gears 90 and the high range sun gear 92 resulting in the low range planetary gear stage 65 having a higher gear ratio (e.g., 7:1) when compared to the gear ratio (e.g., 2.5:1) provided by the high range planetary gear stage 67.

Power in the form of horsepower and torque is generated by the first motor 54. The output shaft 24 of the first motor 54 is supported by the first motor bearing 26. The on/off, forward, and reverse functions of the first motor 10 is controlled by the first motor controller 56. Power generated by the first motor 54 is transferred into the brake assembly 42 which is coupled to the output shaft 24 and supported by the inside of the winch drum 44. Power is then transferred from the brake assembly 42 to the drive shaft 20. Power then flows from the driveshaft 20 through the first planetary gearbox assembly 56 and into the first stage planetary gear assembly 60 which reduces the gear ratio (e.g., 2.67:1, etc.) while increasing torque. Power then travels from the first stage gear assembly 60 into the second stage planetary gear assembly 62 for further gear ratio reduction (e.g., gear ratio of 5:1, etc.). Power then travels out of the second stage planetary gear assembly 62 and into the third stage planetary gear assembly 64.

As described above, the third stage planetary gear assembly 64 has the low gear planetary stage 65 and the high gear planetary stage 67. The low range planetary gear stage 65 multiplies the torque of the first motor 54 to provide “low” range operation (e.g., gear ratio of 7:1, etc.) in order to provide necessary pulling power to recover a full-size off-road vehicle. Once the torque has been multiplied power transfers through the driveshaft 20 and into the other planetary gear stages in the same fashion as a traditional modern winch. The use of the low planetary gear stage 65 results in a slower speed when recovering the winch cable 46. In order to offset this negative characteristic, the system 200 includes the high range planetary gear stage 67 to allow a selective “high” range operation (e.g., gear ratio of 2.5:1, etc.). When the operator uses the gear control assembly 68 to engage the “high” range, the winch cable 46 can be recovered much faster.

Power then travels out of the third stage planetary gear assembly 64 and into the fourth stage planetary gear assembly 66 for further gear reduction (e.g., 4.8:1, etc.) and finally into the winch drum 44. The winch cable 46 is attached to the winch drum 44. The power ultimately transferred into the winch drum 44 is transferred to the winch cable 46.

Using art-disclosed means, the gear control assembly 68 engages with either the low range annular gear 82 or the high range annular gear 96 to provide a significant gear reduction (e.g., gear ratio of 448:1, between 400:1 to 600:1, etc.) for “low” range operation or a lower gear reduction (e.g., gear ratio of 160:1, between 120:1 to 190:1, etc.) for “high” range operation.

In one exemplary embodiment and referring to FIGS. 19-21, the gear control assembly 68 is a clutch having a clutch handle 98, a clutch pin 102, a clutch pin pressure spring 104, a clutch pin retention housing 106, and a clutch pin O-ring 108. The clutch handle 98 is secured to the clutch pin 102 via an art-disclosed fastener 110 (e.g., a socket head cap screw or the like). The clutch pin 102, the clutch pin O-ring 108, the clutch pin pressure spring 104 are housed by the clutch pin retention housing 106. The clutch pin pressure spring 104 and the clutch pin O-ring 108 surrounds the clutch pin 102. The clutch pin O-ring 108 fits a machined groove on the clutch pin 102 to prevent moisture from seeping into the first planetary gearbox assembly 58.

The interior diameter of the clutch pin retention housing 106 is machined to allow the clutch pin 102 to slide up and down when an operator pulls the clutch handle 98. During operation, the clutch pin pressure spring 104 creates a downward force on the clutch pin 102 causing the clutch pin 102 to engage with the notches of either the low range annular gear 82 or the high range annular gear 96 (but not both at the same time) thus locking such notches in place when the clutch is engaged in either “low” range operation or “high” range operation. The clutch handle 98 allows an operator leverage to pull up and turn the clutch pin 102. There are two flat surfaces machined on the inside of the clutch handle 98 which correspond with two similar machined flat surfaced on the outside of the clutch pin retention housing 106. These surfaces are mated when the clutch pin 102 is in the down position. With the surfaces mated, the clutch pin 102 cannot rotate. However once the operator pulls upward, thus overcoming the force of the clutch pin pressure spring 104, the surfaces clear each other and the clutch pin 102 may be rotated.

As shown in FIGS. 19-21, the low range planetary gear stage 65 located on one side provides significant gear reduction for “low” range operation while the high range planetary gear stage 67 located on the other side provides limited gear reduction for “high” speed operation of the system 200. Depending on the rotational position of the clutch pin 102, either the low range annular gear 82 or the high range annular gear 96 will be locked in place. Actual gear reduction in the third stage planetary gear assembly 64 is determined by whether the low range annular gear 82 or the high range annular gear 96 is retained. If the low range annual gear 82 is fixed by the gear control assembly 68, then the system 200 will have maximum pulling power. If the high range annular gear 96 is fixed by the gear control assembly 68, then the system 200 winch will have maximum speed when the clutch pin 102 is locked in the upward position. When an operator of the system 200 pulls up on the clutch handle 98 and rotates the clutch handle 98 by 90 degrees, both the low range annular gear 82 and the high range annular gear 96 may spin freely. In this scenario, the winch system 200 may free spool thus allowing the operator to pull out the winch cable 46 manually.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

What is claims is:

1. A compact winch system comprising a winch assembly, a housing for the winch assembly, and a winch cable wherein:
the winch assembly includes a direct current motor having an output shaft, a motor controller controls the motor, a drive shaft, a brake assembly, and a planetary gearbox assembly coupled to the drive shaft, and a winch drum;
the planetary gearbox assembly includes a first planetary stage assembly, a second planetary stage assembly, a third planetary stage assembly, and a fourth planetary stage assembly;
the third planetary stage assembly allows for selection of a high gear ratio for the system and a low gear ratio for the system by having a low range planetary stage and a high range planetary stage;
the high gear ratio is provided by the system when the low range planetary stage is selected;
the low gear ratio is provided by the system when the high range planetary stage is selected;
the selection between the high gear ratio for the system and the low fear ratio for the system is controlled by a gear control assembly.

2. The compact winch system of claim 1 wherein:
the low range planetary gear stage includes a low range annular gear, low range planet gears, and a low range sun gear;
the high range planetary gear stage includes high range planet gears, a high range sun gear, and a high range annular gear;
the third stage planetary gear assembly further includes a first outer carrier plate assembly, a second carrier plate assembly, and an outer carrier plate;
the low range planet gears are retained between the first outer carrier plate assembly and the second carrier plate assembly;
the low range planet gears are located inside and in communication with the low range annular gear;
the low range planet gears revolve around a sun gear of the fourth stage planetary gear assembly;
the high range planet gears are retained between the second carrier plate assembly and the outer carrier plate;
the high range planet gears are located inside and in communication with the high range annular gear; and
the high range planet gears revolve around the high range sun gear.

3. The compact winch system of claim 2 wherein the selection of the high gear ratio for the system requires the gear control assembly to engage with the low range annular gear.

4. The compact winch system of claim 2 wherein the selection of the low gear ratio for the system requires the gear control assembly to engage with the high range annular gear.

5. The compact winch system of claim 1 wherein the gear control assembly includes a clutch handle, a clutch pin, a clutch pin pressure spring, and a clutch pin retention housing;
the clutch handle is secured to the clutch pin via an art-disclosed fastener; and
interior diameter of the clutch pin retention housing is machined to allow the clutch pin to slide up and down when the clutch handle is pulled.

6. The compact winch system of claim 1 wherein the motor has less than 5 horsepower.

7. The compact winch system of claim 1 wherein the motor has a horsepower in the range between 1.5 and 2.2.

8. The compact winch system of claim 1 wherein the high gear ratio for the system is in the range between 400:1 to 600:1.

9. The compact winch system of claim 1 wherein the low gear ratio for the system is in the range between 120:1 to 190:1.

10. The compact winch system of claim 1 wherein the low gear ratio for the system is in the range between 60:1 to 150:1.

11. The compact winch system of claim 1 wherein the motor controller is located to side of the motor.

12. A compact winch system comprising a winch assembly, a housing for the winch assembly, and a winch cable wherein:
the winch assembly includes a direct current motor having an output shaft, a motor controller controls the motor, a drive shaft, a brake assembly, and a planetary gearbox assembly coupled to the drive shaft, and a winch drum;
the planetary gearbox assembly includes a first planetary stage assembly, a second planetary stage assembly, a third planetary stage assembly, and a fourth planetary stage assembly;
the motor is rated for less than five horsepower;
the third planetary stage assembly allows for selection of a high gear ratio for the system and a low gear ratio for the system by having a low range planetary stage and a high range planetary stage;
the high gear ratio is provided by the system when the low range planetary stage is selected;
the high gear ratio has a range between 400:1 and 600:1;
the low gear ratio is provided by the system when the high range planetary stage is selected;
the low gear ratio has a range between 60:1 to 190:1; and
the selection between the high gear ratio for the system and the low fear ratio for the system is controlled by a gear control assembly.

13. The compact winch system of claim 12 wherein the motor has a horsepower in the range between 1.5 and 2.2.

14. The compact winch system of claim 12 wherein:
the low range planetary gear stage includes a low range annular gear, low range planet gears, and a low range sun gear;
the high range planetary gear stage includes high range planet gears, a high range sun gear, and a high range annular gear;
the third stage planetary gear assembly further includes a first outer carrier plate assembly, a second carrier plate assembly, and an outer carrier plate;
the low range planet gears are retained between the first outer carrier plate assembly and the second carrier plate assembly;
the low range planet gears are located inside and in communication with the low range annular gear;
the low range planet gears revolve around a sun gear of the fourth stage planetary gear assembly;
the high range planet gears are retained between the second carrier plate assembly and the outer carrier plate;
the high range planet gears are located inside and in communication with the high range annular gear; and
the high range planet gears revolve around the high range sun gear.

15. The compact winch system of claim 14 wherein the selection of the high gear ratio for the system requires the gear control assembly to engage with the low range annular gear.

16. The compact winch system of claim 14 wherein the selection of the low gear ratio for the system requires the gear control assembly to engage with the high range annular gear.

17. The compact winch system of claim 1 wherein the low gear ratio for the system is in the range between 60:1 to 150:1.

18. The compact winch system of claim 1 wherein the low gear ratio for the system is in the range between 120:1 to 190:1.

19. The compact winch system of claim 12 wherein
the gear control assembly includes a clutch handle, a clutch pin, a clutch pin pressure spring, and a clutch pin retention housing;
the clutch handle is secured to the clutch pin via an art-disclosed fastener; and
interior diameter of the clutch pin retention housing is machined to allow the clutch pin to slide up and down when the clutch handle is pulled.

20. A compact winch system comprising a winch assembly, a housing for the winch assembly, and a winch cable wherein
the winch assembly includes a motor having an output shaft, a motor controller controls the motor, a motor spur gear having a first diameter and a first tooth count, a drum spur gear having a second diameter and a second tooth count, a drive shaft, a brake assembly, and a planetary gearbox assembly coupled to the drive shaft, and a winch drum;
the first diameter of the motor spur gear is smaller than the second diameter of the drum spur gear;
the first tooth count of the motor spur gear is lesser than the second tooth count of the drum spur gear;
the motor spur gear is coupled to the output shaft;
the drum spur gear is coupled to the planetary gearbox assembly via the brake assembly and the drive shaft;
the motor outputs power in a form of speed and torque to the motor spur gear via the output shaft;
the motor spur gear engages with the drum spur gear to transfer the power to the drum side spur, then into the brake assembly, the drive shaft, and the planetary gearbox assembly;
the engagement of the motor gear with the drum spur gear multiplies the torque generated by the motor, moves axis of the power's flow from the motor to the planetary gearbox assembly with an offset of the motor's location to create a desired physical location for the motor; and
the planetary gearbox assembly transfers the power into the winch drum and then to the winch cable for use in winching operations.
